(19) United States
(12) Patent Application Publication
(10) Pub. No.: US 2024/0054457 A1
(43) Pub. Date: Feb. 15, 2024

(54) SYSTEMS AND METHODS FOR SENDING AN INDICATION THAT A DIGITAL RECEIPT IS TO BE PROVIDED FOR A PURCHASE MADE ON A PAYMENT CARD

(71) Applicant: The Toronto-Dominion Bank, Toronto (CA)

(72) Inventors: Dinshaw BHARUCHA, Toronto (CA); Romy MOGHAIZEL, Richmond Hill (CA); Vingston SATGUNAM, Toronto (CA); Alexandra Clarissa Marie AMOURGIS, Toronto (CA)

(73) Assignee: The Toronto-Dominion Bank, Toronto, ON (CA)

(21) Appl. No.: 17/884,093

(22) Filed: Aug. 9, 2022

(51) Int. Cl. G06Q 20/04; G06Q 20/20; G06Q 20/38

(52) U.S. Cl. CPC G06Q 20/047; G06Q 20/20; G06Q 20/389

(57) ABSTRACT

A server computer system comprises a communications module; a processor coupled to the communications module; and a memory coupled to the processor, the memory storing processor-executable instructions which, when executed, configure the processor to store, in a database, an indication that digital receipts are to be provided for all purchases made on a payment card; receive, via the communications module and from a point-of-sale system, a signal requesting an indication that a digital receipt is to be provided for a purchase made on the payment card; consult the database to determine that the digital receipt is to be provided for the purchase made on the payment card; and send, via the communications module and to the point-of-sale system, a signal that includes the indication that the digital receipt is to be provided for the purchase made on the payment card.

### TECHNICAL FIELD

The present disclosure relates to systems and methods for sending an indication that a digital receipt is to be provided for a purchase made on a payment card.

### BACKGROUND

Some merchants allow a user to request a digital receipt by entering their email address at the point-of-sale. This process is laboursome. Further, the user may not want to share their email address with the merchant as this may expose the email address to digital security threats.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified schematic diagram showing components of a point-of-sale system;

FIG. 3 is a high-level schematic diagram of an example computer device;

FIG. 4 shows a simplified organization of software components stored in a memory of the example computer device of FIG. 3;

FIG. 5 is a flowchart showing operations performed in sending an indication that a digital receipt is to be provided for a purchase made on a payment card according to an embodiment;

FIG. 6 is a flowchart showing operations performed in receiving a signal indicating selection of a selectable option to receive digital receipts according to an embodiment;

FIG. 7 is an example user interface that includes a selectable option to receive digital receipts according to an embodiment;

FIG. 8 is a flowchart showing operations performed in completing a transaction based on a transaction processing request according to an embodiment;

FIG. 9 is a flowchart showing operations performed in sending a digital receipt to an electronic address according to an embodiment;

FIG. 10 is an example of an updated or augmented digital receipt according to an embodiment;

FIG. 11 is a flowchart showing operations performed in generating a user interface that includes digital receipts according to an embodiment;

FIG. 12 is an example user interface of a digital receipt management application according to an embodiment; and

FIG. 13 is a flowchart representation of a digital receipt aggregator according to an embodiment.

Like reference numerals are used in the drawings to denote like elements and features.

### DETAILED DESCRIPTION OF VARIOUS EMBODIMENTS

Accordingly, in an aspect there is provided a server computer system comprising a communications module; a processor coupled to the communications module; and a memory coupled to the processor, the memory storing processor-executable instructions which, when executed, configure the processor to store, in a database, an indication that digital receipts are to be provided for all purchases made on a payment card; receive, via the communications module and from a point-of-sale system, a signal requesting an indication that a digital receipt is to be provided for a purchase made on the payment card; consult the database to determine that the digital receipt is to be provided for the purchase made on the payment card; and send, via the communications module and to the point-of-sale system, a signal that includes the indication that the digital receipt is to be provided for the purchase made on the payment card.

In one or more embodiments, the signal requesting the indication that the digital receipt is to be provided for the purchase made on the payment card is sent together with a transaction processing request.

In one or more embodiments, the processor-executable instructions, when executed, further configure the processor to complete a transaction based on the transaction processing request; and send, via the communications module and to the point-of-sale system, a signal that indicates completion of the transaction processing request.

In one or more embodiments, the signal that indicates completion of the transaction processing request is sent together with the signal that includes the indication that the digital receipt is to be provided for the purchase made on the payment card.

In one or more embodiments, the processor-executable instructions, when executed, further configure the processor to store, in the database, an electronic address for receiving the digital receipts, wherein the electronic address is sent together with the signal that includes the indication that the digital receipt is to be provided for the purchase made on the payment card.

In one or more embodiments, the processor-executable instructions, when executed, further configure the processor to send, via the communications module and to a computing device, a signal that causes the computing device to display a user interface that includes a selectable option to receive the digital receipts; and receive, via the communications module and from the computing device, a signal indicating selection of the selectable option to receive the digital receipts.

In one or more embodiments, the user interface includes an input field for entering an electronic address for receiving the digital receipt and the processor-executable instructions, when executed, further configure the processor to receive, via the communications module and from the computing device, a signal that includes the electronic address for receiving the digital receipt; and store, in the database, the electronic address for receiving the digital receipts.

In one or more embodiments, the processor-executable instructions, when executed, further configure the processor to receive, via the communications module and from the point-of-sale system, a signal that includes the digital receipt for the purchase made on the payment card; obtain an electronic address for receiving the digital receipt; and send, via the communications module and to the electronic address, the digital receipt.

In one or more embodiments, the processor-executable instructions, when executed, further configure the processor to prior to sending the digital receipt analyze the digital receipt to determine a transaction amount; determine an amount of loyalty points earned based on the transaction amount; and modify the digital receipt to include the amount of loyalty points earned based on the transaction amount.

In one or more embodiments, the processor-executable instructions, when executed, further configure the processor to send, via the communications module and to a computing device, a signal that causes the computing device to display a user interface that includes the digital receipt.

In one or more embodiments, the user interface displays a plurality of digital receipts and includes one or more interface elements for categorizing each digital receipt in one or more data buckets.

In one or more embodiments, the indication indicating that digital receipts are to be provided for all purchases made on the payment card is stored in the database and sent to the point-of-sale system as a binary flag.

According to another aspect there is provided a computer-implemented method performed by a processor of a server computer system, the method comprising storing, in a database, an indication indicating that digital receipts are to be provided for all purchases made on a payment card; receiving, via a communications module and from a point-of-sale system, a signal requesting an indication that a digital receipt is to be provided for a purchase made on the payment card; consulting the database to determine that the digital receipt is to be provided for the purchase made on the payment card; and sending, via the communications module and to the point-of-sale system, a signal that includes the indication that the digital receipt is to be provided for the purchase made on the payment card.

In one or more embodiments, the signal requesting the indication that the digital receipt is to be provided for the purchase made on the payment card is sent together with a transaction processing request.

In one or more embodiments, the method further comprises completing a transaction based on the transaction processing request; and sending, via the communications module and to the point-of-sale system, a signal that indicates completion of the transaction processing request.

In one or more embodiments, the signal that indicates completion of the transaction processing request is sent together with the signal that includes the indication that the digital receipt is to be provided for the purchase made on the payment card.

In one or more embodiments, the method further comprises storing, in the database, an electronic address for receiving the digital receipts, wherein the electronic address is sent together with the signal that includes the indication that the digital receipt is to be provided for the purchase made on the payment card.

In one or more embodiments, the method further comprises receiving, via the communications module and from the point-of-sale system, a signal that includes the digital receipt for the purchase made on the payment card; obtaining an electronic address for receiving the digital receipt; and sending, via the communications module and to the electronic address, the digital receipt.

In one or more embodiments, the method further comprises, prior to sending the digital receipt, analyzing the digital receipt to determine a transaction amount; determining an amount of loyalty points earned based on the transaction amount; and modifying the digital receipt to include the amount of loyalty points earned based on the transaction amount.

According to another aspect there is provided a non-transitory computer-readable storage medium storing instructions that when executed by a processor of a computing system cause the computing system to store, in a database, an indication indicating that digital receipts are to be provided for all purchases made on a payment card; receive, via a communications module and from a point-of-sale system, a signal requesting an indication that a digital receipt is to be provided for a purchase made on the payment card; consult the database to determine that the digital receipt is to be provided for the purchase made on the payment card; and send, via the communications module and to the point-of-sale system, a signal that includes the indication that the digital receipt is to be provided for the purchase made on the payment card.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

Merchants may allow customers to request digital receipts and often require users to enter their email address at the point-of-sale. This process is laboursome as the user must provide their email address to every merchant they want to receive digital receipts from and this must always be done at the point-of-sale. Further, oftentimes users may not want to share their email address with the merchant as this may lead to an increase in email spam.

Systems and methods for sending an indication that a digital receipt is to be provided for a purchase made on a credit card are described below. The system and methods automatically send, to a point-of-sale system, an indication that a digital receipt is to be provided for a purchase made on a payment card. In one or more embodiments, the indication is sent as a binary flag and this is done to reduce the amount of computing resources such as bandwidth required to request and obtain a digital receipt. The reduction in the amount of computing resources required may further help to decrease the time it takes to request the digital receipt.

In one or more embodiments, the digital receipt may be provided directly to a server associated with the payment card used to complete the purchase. Specifically, the server may receive the digital receipt from the point-of-sale system and may automatically send the digital receipt to an electronic address of the user and/or store the digital receipt in a database in association with the payment card. In this manner, digital receipts may be handled by the server associated with the payment card such that the electronic address of the user is not shared with the point-of-sale system or any computer systems of the merchant. The electronic address of the user is thus protected from digital security threats that may be posed to the point-of-sale system(s) and/or the computer systems of the merchant.

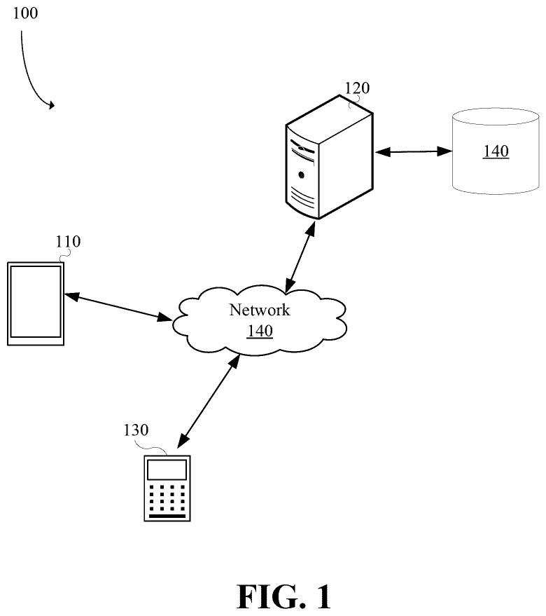

FIG. 1 is a schematic operation diagram illustrating an operating environment of an example embodiment of a system 100 for sending an indication that a digital receipt is to be provided for a purchase made on a payment card.

As shown in FIG. 1, the system 100 includes a computing device 110, a server computer system 120 and a point-of-sale system 130 coupled to one another through a network 140, which may include a public network such as the Internet and/or a private network. The computing device 110, the server computer system 120 and the point-of-sale system 130 may be in geographically disparate locations. Put differently, the computing device 110, the server computer system 120 and the point-of-sale system 130 may be located remote from one another.

The computing device 110 may be a mobile device as shown in FIG. 1. However, the computing device 110 may be a computing device of another type such as for example a personal computer, a laptop computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The server computer system 120 is a computer server system. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The server computer system 120 may be associated with a financial institution. The server computer system 120 may be configured to process or complete financial transactions based on transaction requests received from the point-of-sale system 130. As will be described in more detail below, the server computer system 120 may be configured to send an indication that a digital receipt is to be provided for a payment made on a payment card.

The server computer system 120 may maintain a database 150 that stores data records. The data records may include data associated with customer accounts and the customer accounts may include payment card accounts. For each payment account maintained thereby, the database 150 may store an indication as to whether digital receipts are to be provided for all purchases made on the payment card and/or may store digital receipts received from the point-of-sale system 130.

The point-of-sale system 130 may be associated with a merchant and may be used to complete a purchase. To complete the purchase, the point-of-sale system 130 may receive a token. The token may be, for example, a payment card that may be associated with a particular financial institution or payment card provider. The token may be, for example, a debit card or a credit card.

Responsive to receiving the token, the point-of-sale system 130 may display a prompt to provide a PIN associated with the token. The PIN may be entered using an input device such as for example a keypad associated with the point-of-sale system 130. The PIN may be used to authenticate the token.

Responsive to successful authentication of the token, the point-of-sale system 130 may be configured to generate or initiate a transaction request and send the transaction request to the server computer system 120. The transaction request may be associated with a purchase being made on a payment card.

The point-of-sale system 130 may be configured to generate or initiate a request for an indication that a digital receipt is to be provided for the purchase made on the payment card. The point-of-sale system 130 may be configured to send the request for the indication that the digital receipt is to be provided for the purchase made on the payment card and the transaction request simultaneously.

Responsive to completion of the purchase made on the payment card, the point-of-sale system 130 may be configured to send a digital receipt to the server computer system 120 and/or to an electronic address associated with the payment card.

The network 140 is a computer network. In some embodiments, the network 140 may be an internetwork and may be formed of one or more interconnected computer networks. For example, the network 140 may be or may include an Ethernet network, an asynchronous transfer mode (ATM) network, a wireless network, a telecommunications network or the like.

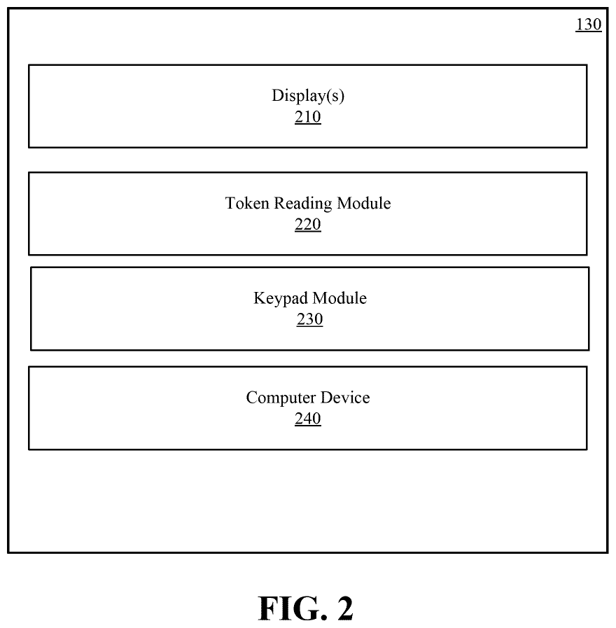

FIG. 2 is a simplified schematic diagram showing components of the point-of-sale system 130. The point-of-sale system 130 may include modules including, as illustrated, for example, one or more displays 210, a token interface 220, a keypad module 230 and a computing device 240.

The one or more displays 210 are a display module. The one or more displays 210 are used to display screens of a graphical user interface that may be used, for example, to display instructions to the user.

The token interface 220 may be used to receive and/or read a token such as for example a debit card or a credit card. For example, the token interface 220 may be configured to read data from a chip physically located on the token. The token interface 220 may utilize near field communications (NFC) to read data from the chip located on the token.

The keypad module 230 may be used to receive input from the user. For example, the keypad module 230 may be used by the user to enter a PIN and/or to provide answers to questions displayed by the display module 210. Further, the keypad module 230 may be used to enter a transaction amount.

The computer device 240 is in communication with the one or more displays 210, the token interface 220, and the keypad module 230. The computer device 240 may be or may include a processor which is coupled to the one or more displays 210, the token interface 220, and/or the keypad module 230.

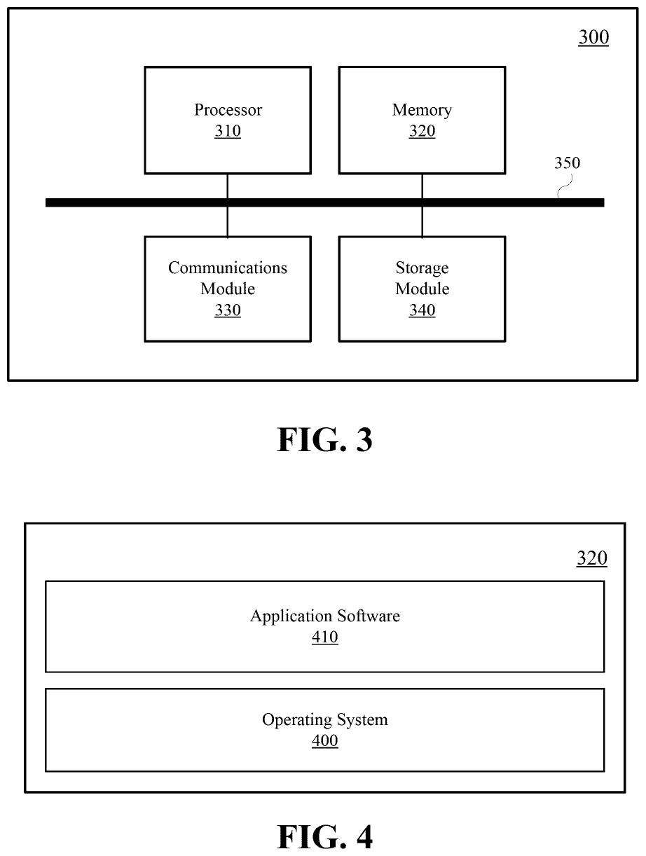

Referring now to FIG. 3, a high-level operation diagram of an example computer device 300 is shown. In some embodiments, the computer device 300 may be exemplary of the computing device 110 (FIG. 1), the server computer system 120 (FIG. 1) and/or the computer device 240 (FIG. 2).

The example computer device 300 includes a variety of modules. For example, as illustrated, the example computer device 300 may include a processor 310, a memory 320, a communications module 330, and/or a storage module 340. As illustrated, the foregoing example modules of the example computer device 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computer device 300.

The communications module 330 allows the example computer device 300 to communicate with other computer or computing devices and/or various communications networks. For example, the communications module 330 may allow the example computer device 300 to send or receive communications signals. Communications signals may be sent or received according to one or more protocols or according to one or more standards. For example, the communications module 330 may allow the example computer device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computer device 300 to communicate using near-field communication (NFC), via Wi-Fi™, using Bluetooth™ or via some combination of one or more networks or protocols. In some embodiments, all or a portion of the communications module 330 may be integrated into a component of the example computer device 300. For example, the communications module may be integrated into a communications chipset. In some embodiments, the communications module 330 may be omitted such as, for example, if sending and receiving communications is not required in a particular application.

The storage module 340 allows the example computer device 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the processor 310 in concert with the communications module 330 such as, for example, if data is stored remotely. The storage module may also be referred to as a data store.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the example computer device 300 (FIG. 3). As illustrated, these software components include an operating system 400 and an application 410.

The operating system 400 is software. The operating system 400 allows the application 410 to access the processor 310 (FIG. 3), the memory 320, and the communications module 330 of the example computer device 300 (FIG. 3). The operating system 400 may be, for example, Google™ Android™, Apple™ iOS™, UNIX™, Linux™, Microsoft™ Windows™, Apple OSX™ or the like.

The application 410 adapts the example computer device 300, in combination with the operating system 400, to operate as a device performing a particular function. For example, the application 410 may cooperate with the operating system 400 to adapt a suitable embodiment of the example computer device 300 to operate as the computing device 110 (FIG. 1), the server computer system 120 (FIG. 1) and/or the computing device 240 (FIG. 2) of the point-of-sale system 130 (FIG. 1).

While a single application 410 is illustrated in FIG. 3, in operation the memory 320 may include more than one application 410 and different applications 410 may perform different operations. For example, in at least some embodiments in which the computer device 300 is functioning as the computing device 110, the applications 410 may include a payment card management application.

The payment card management application may be configured to present one or more graphical interfaces on a display of the computing device 110 and may provide various payment card management functions. As will be described in more detail below, the payment card management functions may include providing an indication for receiving digital receipts for all purchases made on the payment card.

As another example, in at least some embodiments in which the computer device 300 is functioning as the computing device 110, the applications 410 may include a digital receipt management application. The digital receipt management application may be included with or associated with the payment card management application or may be a separate application. The digital receipt management application may be configured to present one or more graphical interfaces on a display of the computing device 110 that include one or more digital receipts and may provide various digital receipt management functions. The digital receipt management functions may include categorizing digital receipts into one or more data buckets.

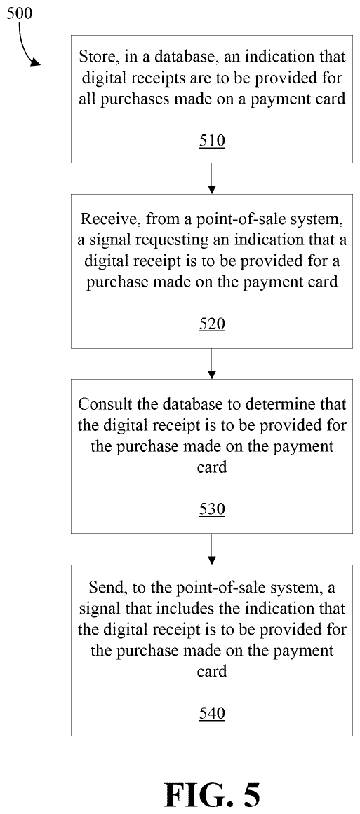

Reference is made to FIG. 5 which illustrates, in flowchart form, a method 500 for sending an indication that a digital receipt is to be provided for a purchase made on a payment card. The method 500 may be implemented by a computing device having suitable processor-executable instructions for causing the computing device to carry out the described operations. The method 500 may be implemented, in whole or in part, by the server computer system 120.

The method 500 includes storing, in a database, an indication indicating that digital receipts are to be provided for all purchases made on a payment card (step 510).

In one or more embodiments, the indication indicating that digital receipts are to be provided for all purchases made on a payment card may be received from the computing device 110. For example, a payment card management application may be installed on the computing device 110 that allows the computing device 110 to communicate with the server computer system 120. The payment card management application may provide various payment card management functions. The payment card management functions may include providing an indication for receiving digital receipts for all purchases made on the payment card. The user may select a selectable option indicating that they would like to receive digital receipts for all payments made on the payment card.

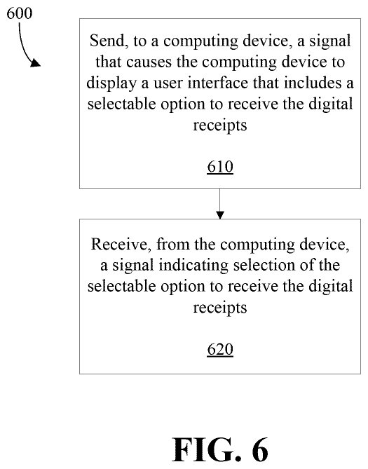

Reference is made to FIG. 6 which illustrates, in flowchart form, a method 600 for receiving a signal indicating selection of a selectable option to receive digital receipts. The method 600 may be implemented by a computing device having suitable processor-executable instructions for causing the computing device to carry out the described operations. The method 600 may be implemented, in whole or in part, by the server computer system 120.

The method 600 includes sending, to a computing device, a signal that causes the computing device to display a user interface that includes a selectable option to receive the digital receipts (step 610).

In one or more embodiments, the user interface may be displayed within the payment card management application. The user interface may be displayed within a settings page within the payment card management application and/or may be displayed as part of activating a payment card within the payment card management application.

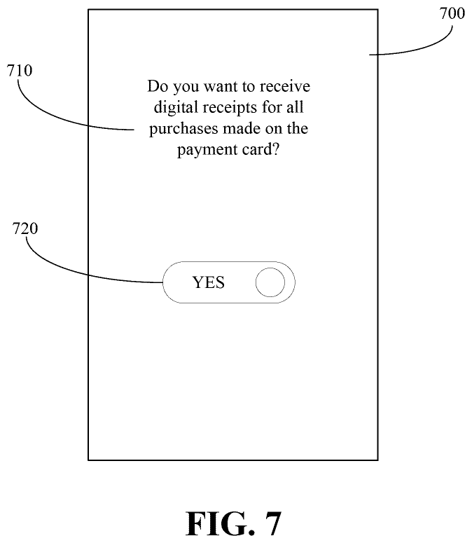

An example user interface 700 is shown in FIG. 7. As can be seen, the user interface 700 includes a message 710 that reads “Do you want to receive digital receipts for all purchases made on the payment card?” The user interface 700 includes a selectable option 720 to receive the digital receipts. In this example, the selectable option 720 is a selectable interface element in the form of a toggle button that may be toggled between “Yes” and “No”. Specifically, the toggle button may be adjusted by a user performing a tap gesture on a display screen of the computing device 110 at a location that corresponds to the location of the toggle button.

The user may adjust the selectable option 720 to indicate that they would like to receive digital receipts for all purchases made on the payment card and in response the computing device 110 may send a signal indicating selection of the selectable option to receive the digital receipts.

The method 600 includes receiving, from the computing device, a signal indicating selection of the selectable option to receive the digital receipts (step 620).

The server computer system 120 receives, from the computing device 110, the signal indicating selection of the selectable option to receive the digital receipts.

Responsive to receiving the signal indicating selection of the selectable option to receive the digital receipts, the server computer system 120 may perform operations to store, in the database 150, an indication that digital receipts are to be provided for all purchases made on the payment card. The indication may be stored in the database 150 in association with the payment card. The payment card may be identified by, for example, a payment card number, a payment card account number, etc.

In one or more embodiments, the indication that digital receipts are to be provided for all purchases made on the payment card may be stored in the database 150 in the form of a binary flag. For example, the indication may be stored as a single bit where a value of “1” may indicate that digital receipts are to be provided and a value of “0” may indicate that digital receipts are not to be provided. In this manner, the indication is stored as a small unit of data such that it occupies limited computer memory within the database 150.

In one or more embodiments, the server computer system 120 may additionally obtain an electronic address for receiving the digital receipt. For example, within the payment card management application, the user interface shown in FIG. 7 may additionally include an input field for entering an electronic address for receiving the digital receipt. The electronic address may include, for example, an email address or a telephone number that may be used to receive the digital receipt via email or text message, respectively. The user may enter the electronic address using an input device associated with the computing device 110 and in response the server computer system 120 may receive, from the computing device 110, a signal that includes the electronic address for receiving the digital receipt. The server computer system 120 may perform operations to store the electronic address for receiving the digital receipt in the database 150. The electronic address may be stored in association with the indication that digital receipts are to be provided for all purchases made on the payment card and/or in association with the payment card.

In one or more embodiments, rather than obtaining the electronic address from the computing device 110, the server computer system 120 may obtain the electronic address from one or more data records previously obtained from the user. For example, the user may have previously linked an email address with the payment card account or with another type of bank account maintained by the server computer system 120 (such as a chequing account, savings account, etc.) and this email address may be set as the electronic address to be used to receive the digital receipts.

Referring back to FIG. 5, the method 500 includes receiving, from a point-of-sale system, a signal requesting an indication that a digital receipt is to be provided for a purchase made on the payment card (step 520).

In one or more embodiments, the point-of-sale system is the point-of-sale system 130. In one or more embodiments, the signal may be sent upon completion of a transaction. Put another way, the payment card may be used to complete payment for a good or service offered by the merchant and once payment has been completed, the point-of-sale system 130 may send, to the server computer system 120, a signal requesting the indication that the digital receipt is to be provided for the purchase made on the payment card.

In one or more embodiments, the server computer system 120 may be identified by the point-of-sale system 130. For example, the point-of-sale system 130 may analyze a payment card number of the payment card to identify a provider of the payment card. The point-of-sale system 130 may determine a server computer system (such as the server computer system 120) as being associated with the provider of the payment card and may send the signal requesting the indication that the digital receipt is to be provided for the purchase made on the payment card to the determined server computer system.

The method 500 includes consulting the database to determine that the digital receipt is to be provided for the purchase made on the payment card (step 530).

Responsive to receiving the signal requesting the indication that the digital receipt is to be provided for the purchase made on the payment card, the server computer system 120 consults the database 150 to determine that the digital receipt is to be provided for the purchase made on the payment card.

In one or more embodiments, the server computer system 120 may consult the database 150 by performing a lookup using one or more identifiers of the payment card. For example, a payment card number of the payment card may be used to perform a lookup to determine whether or not a digital receipt is to be provided for the purchase made on the payment card.

As mentioned, the indication may be stored in the database 150 as a binary flag. In this example, the server computer system 120 may obtain the binary flag from the database 150 where a value of “1” may indicate that digital receipts are to be provided and a value of “0” may indicate that digital receipts are not to be provided.

The method 500 includes sending, via the communications module and to the point-of-sale system, a signal that includes the indication that the digital receipt is to be provided for the purchase made on the payment card (step 540).

Responsive to determining that the digital receipt is to be provided, the server computer system 120 sends a response to the point-of-sale system 130. In one or more embodiments, the response is a signal that includes the indication that the digital receipt is to be provided for the purchase made on the payment card. The indication may be a binary flag where a value of “1” may indicate that digital receipts are to be provided and a value of “0” may indicate that digital receipts are not to be provided. The binary flag may be the same binary flag stored in the database 150. In this manner, the indication is sent to the point-of-sale system as a small unit of data and as such the indication occupies limited computer memory and network bandwidth when being communicated to the point-of-sale system 130 via the network 140.

In one or more embodiments, the server computer system 120 may additionally process a transaction to complete a payment. For example, the server computer system 120 may receive, from the point-of-sale system 130, a transaction processing request and in response perform operations to charge a payment account associated with the payment card to complete a transaction.

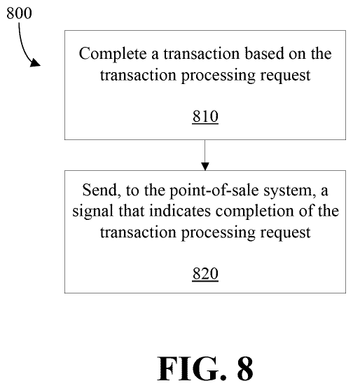

Reference is made to FIG. 8 which illustrates, in flowchart form, a method 800 for completing a transaction based on a transaction processing request. The method 800 may be implemented by a computing device having suitable processor-executable instructions for causing the computing device to carry out the described operations. The method 800 may be implemented, in whole or in part, by the server computer system 120.

The method 800 includes completing a transaction based on a transaction processing request (step 810).

The server computer system 120 may perform operations to complete a payment by charging a payment account associated with the payment card. The transaction processing request may include an amount of the transaction and may include an identifier of the payment card and/or the payment account that is to be used to process the transaction.

The method 800 includes sending, to the point-of-sale system, a signal that indicates completion of the transaction processing request (step 820).

Responsive to completing the transaction based on the transaction processing request, the server computer system 120 sends, to the point-of-sale system 130, a signal that indicates completion of the transaction processing request.

In one or more embodiments, the server computer system 120 may simultaneously process a transaction and may obtain an indication that a digital receipt is to be provided for the transaction. For example, in one or more embodiments, the signal requesting the indication that a digital receipt is to be provided for a purchase made on the payment card may be sent together with a transaction processing request. In this example, the signal that indicates completion of the transaction processing request may be sent together with the signal that includes the indication that the digital receipt is to be provided for the purchase made on the payment card. In this manner, the server computer system 120 receives a signal from the point-of-sale system 130 that includes a transaction processing request and a request for an indication that a digital receipt is to be provided. The server computer system 120 performs operations, as described herein, to complete the transaction processing request and to determine that the digital receipt is to be provided for the purchase made on the payment card. The server computer system 120 sends, to the point-of-sale system 130, a signal that indicates completion of the transaction processing request and that includes the indication that the digital receipt is to be provided for the purchase made on the payment card. In this manner, communication between the point-of-sale system 130 and the server computer system 120 is minimized and as a result the reliance on computing resources such as for example network bandwidth is reduced. Put another way, by minimizing communication between the point-of-sale system 130 and the server computer system 120, the reliance on network bandwidth of the network 140 is reduced or minimized.

Responsive to receiving the signal that includes the indication that the digital receipt is to be provided for the purchase made on the payment card, the point-of-sale system 130 may generate and send the digital receipt.

In one or more embodiments, the point-of-sale system 130 may send the digital receipt to the electronic address associated with the payment card. In these embodiments, the server computer system 120 may obtain an electronic address associated with the payment card from the database 150 and may send the electronic address associated with the payment card together with the signal that includes the indication that the digital receipt is to be provided for the purchase made on the payment card. The point-of-sale system 130 may receive the signal that includes the indication that the digital receipt is to be provided for the purchase made on the payment card and the electronic address associated with the payment card and may perform operations to send the digital receipt to the electronic address associated with the payment card. In this manner, the digital receipt may be sent directly from the merchant to the electronic address associated with the payment card.

In one or more embodiments, the point-of-sale system 130 may send the digital receipt to the server computer system 120 via the network 140. As mentioned, the database 150 may store an electronic address associated with the payment card and as such, in response to receiving the digital receipt, the server computer system 120 may consult the database to obtain the electronic address associated with the payment card and may send the digital receipt to thereto.

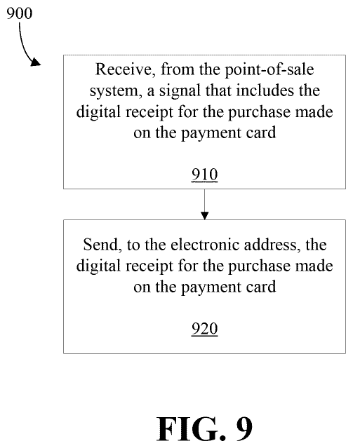

Reference is made to FIG. 9 which illustrates, in flowchart form, a method 900 for sending a digital receipt to an electronic address. The method 900 may be implemented by a computing device having suitable processor-executable instructions for causing the computing device to carry out the described operations. The method 900 may be implemented, in whole or in part, by the server computer system 120.

The method 900 includes receiving, from a point-of-sale system, a signal that includes a digital receipt for a purchase made on a payment card (step 910).

In response to receiving the signal that includes the indication that the digital receipt is to be provided for the purchase made on the payment card, the point-of-sale system 130 may generate and send a digital receipt to the server computer system 120.

The method 900 includes sending, to the electronic address, the digital receipt for the purchase made on the payment card (step 920).

Responsive to receiving the digital receipt, the server computer system 120 may consult the database 150 to obtain the electronic address associated with the payment card. The electronic address may be, for example, an email address. The server computer system 120 may send the digital receipt to the email address.

In one or more embodiments, prior to sending the digital receipt to the electronic address, the server computer system 120 may analyze the digital receipt and may update or augment the digital receipt. For example, the server computer system 120 may engage an optical character recognition (OCR) engine that may be used to analyze the digital receipt to extract data such as for example a transaction or purchase amount. The server computer system 120 may calculate an amount of loyalty points earned for the purchase. For example, the particular payment card used to complete the purchase may cause the customer to earn one hundred (100) loyalty points for every dollar spent on the payment card. As such, the server computer system 120 may calculate the amount of loyalty points earned for the purchase by multiplying the purchase amount by one hundred (100). In this manner, the digital receipt may be stored in the database 150 and/or sent to the electronic address such that the digital receipt includes an amount of loyalty points earned for the purchase.

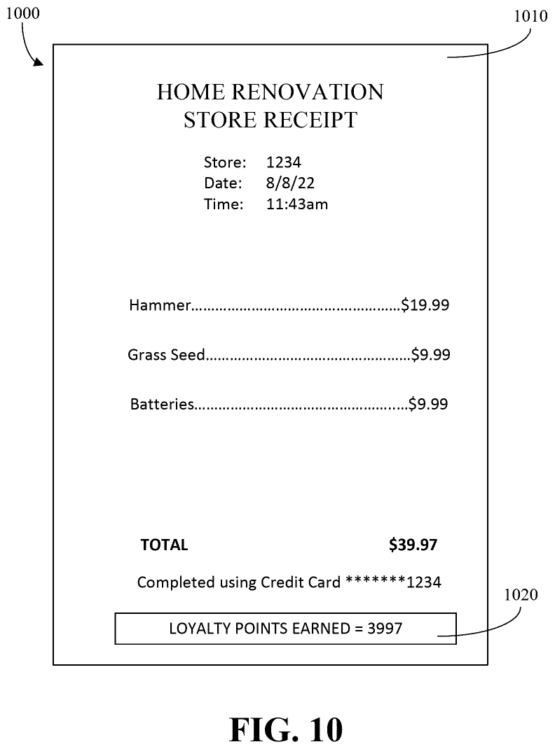

An example of an updated or augmented digital receipt 1000 is shown in FIG. 10. In this example, the server computer system 120 receives the digital receipt 1010 which includes a list of items purchased (hammer, grass seed, batteries) and a purchase amount ($39.97). The server computer system 120 engages the OCR engine to analyze the digital receipt to extract the purchase amount ($39.97). The server computer system 120 calculates the amount of loyalty points earned for the purchase by multiplying the purchase amount by a ratio of loyalty points to dollars, which in this example is 100:1. As such, the server computer system 120 determines that the total amount of loyalty points earned for the purchase is three thousand nine-hundred and ninety-seven (3997) loyalty points. The server computer system 120 updates the digital receipt 1010 to include a label 1020 that indicates the amount of loyalty points earned and the updated or augmented digital receipt 1000 is sent to the electronic address and/or stored in the database 150.

It will be appreciated that in one or more embodiments, rather than calculating the amount of loyalty points earned, the server computer system 120 may consult a database, such as database 150, to analyze loyalty point account data to identify an amount of loyalty points earned for the purchase. In these embodiments, the server computer system 120 may compare the loyalty point account data to data retrieved from the digital receipt via the OCR engine to identify or determine the amount of loyalty points earned for the purchase. The data that may be used to compare may include a time, a date, an amount of the purchase, the name of the merchant, etc.

As described herein with reference to method 900, the server computer system 120 obtains the digital receipt and sends the digital receipt to the electronic address associated with the payment card. In this manner, the electronic address associated with the payment card is not shared with the point-of-sale system 130 and thus the merchant does not receive and does not have access to the electronic address associated with the payment card. As such, the electronic address associated with the payment card is protected from digital security threats that may be posed to the point-of-sale system(s) and/or the computer systems of the merchant. Further, since the merchant does not receive and does not have access to the electronic address associated with the payment card, the merchant is not able to send potentially unwanted communications such as email spam to that electronic address. Still further, in embodiments where the server computer system 120 updates or augments the digital receipt to include additional information such as loyalty point information, the digital receipt may be stored or sent to the electronic address to include information that may not otherwise be available if the digital receipt was sent directly from the merchant to the electronic address.

It will be appreciated that in one or more embodiments, the server computer system 120 may additionally or alternatively store the digital receipt in the database 150 in association with the payment card. In these embodiments, the server computer system 120 may generate an interface that may be used to view and organize digital receipts.

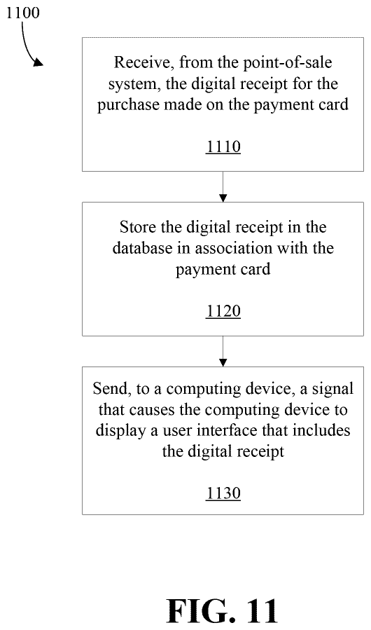

Reference is made to FIG. 11 which illustrates, in flowchart form, a method 1100 for generating a user interface that includes digital receipts. The method 1100 may be implemented by a computing device having suitable processor-executable instructions for causing the computing device to carry out the described operations. The method 1100 may be implemented, in whole or in part, by the server computer system 120.

The method 1100 includes receiving, from the point-of-sale system, the digital receipt for the purchase made on the payment card (step 1110).

In response to receiving the signal that includes the indication that the digital receipt is to be provided for the purchase made on the payment card, the point-of-sale system 130 may generate and send a digital receipt to the server computer system 120.

The method 1100 includes storing the digital receipt in the database in association with the payment card (step 1120).

Responsive to receiving the digital receipt, the server computer system 120 may perform operations to store the digital receipt in the database 150 in association with the payment card. The digital receipt may be stored in a standard format such as a portable document format (*.pdf) file that may be easily retrieved and displayed on the computing device 110.

The method 1100 includes sending, to a computing device, a signal that causes the computing device to display a user interface that includes the digital receipt (step 1130).

The digital receipt may be retrieved from the database 150 and displayed within a user interface on the computing device 110. For example, a digital receipt management application may be installed on the computing device 110 that allows the computing device 110 to communicate with the server computer system 120 to display digital receipts within the user interface.

In one or more embodiments, the user interface may display a plurality of digital receipts and may include one or more interface elements for categorizing each digital receipt into one or more data buckets. For example, within the digital receipt management application, all digital receipts associated with a payment card may be displayed. In this example, each digital receipt may be displayed as a thumbnail image. Within the digital receipt management application, one or more data buckets may be created. One example data bucket may include a “home renovation” data bucket. The user may select one or more digital receipts to be included in the “home renovation” data bucket. The server computer system 120 may engage an optical character recognition (OCR) engine that may be used to analyze the digital receipts to extract data such as for example a transaction amount. The server computer system 120 may calculate a total transaction amount for all digital receipts included in the data bucket and may display the total transaction amount adjacent to a title of each data bucket.

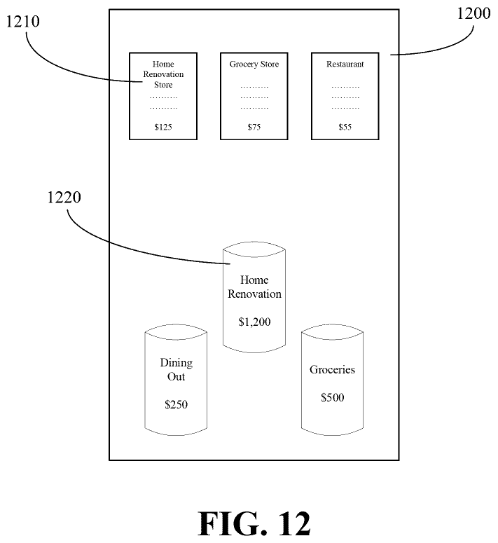

An example user interface 1200 is shown in FIG. 12. As can be seen, the user interface 1200 displays a number of digital receipts, where each digital receipt is displayed as a thumbnail image 1210. Each thumbnail image 1210 is a representation of a corresponding digital receipt. In one or more embodiments, each thumbnail image 1210 may display or include a category, a merchant, a date and an amount of the purchase (or the amount of each item). Further, in one or more embodiments, each thumbnail image 1210 may include an amount of loyalty points earned for the purchase.

Each thumbnail image 1210 is selectable by, for example, performing a tap gesture at a location on a display screen of the computing device 110 that corresponds to the location of the thumbnail image 1210. Responsive to selection of the thumbnail image 1210, the digital receipt may be displayed.

The user interface 1200 also displays a number of data buckets 1220. In the example shown, the data bucket 1220 include a “Home Renovation” data bucket, a “Dining Out” data bucket, and a “Groceries” data bucket. The title of each data bucket and the total for all digital receipts dropped in the data bucket are displayed. Each thumbnail image 1210 may be dragged and dropped into a data bucket 1220 and in response, the user interface 1200 may be updated to remove the digital receipt from the display and to update the data bucket to indicate a new total for the data bucket 1220. The new total may be calculated by summing the amount of the digital receipt dropped in the data bucket 1220 with the current total of the data bucket 1220.

In one or more embodiments, the OCR engine may analyze the digital receipts to extract data such as for example a name of each item purchased. In this example, the server computer system 120 may engage a machine-learning engine and/or an artificial intelligence engine that may be used to categorize each item into a particular data bucket. For example, a digital receipt from a home renovation store may include items associated with a bathroom renovation and items associated with lawn maintenance. As such, the artificial intelligence engine may associate items such as “soil” and “grass seed” with a data bucket labelled “lawn care” and may associate items such as a “toilet” and “shower tiles” with a data bucket labelled “bathroom renovation.” The data buckets may be labelled by the user within the digital receipt management application or may be automatically created by the artificial intelligence engine.

In one or more embodiments, the server computer system 120 may obtain digital receipts from multiple payment cards and may combine, consolidate, or aggregate all digital receipts into the digital receipt management application. For example, the server computer system 120 may obtain digital receipts for purchases made on a particular credit card and on a particular debit card and may store the digital receipts in the database 150 in association with a particular account. A user of the account may view and organize the digital receipts within the digital receipt management application in manners described herein. Further, the user may upload digital receipts for payments made on one or more third party payment cards and these digital receipts may be viewed and organized within the digital receipt management application. It will be appreciated that the server computer system 120 may obtain the digital receipts in real-time and as such the digital receipt management application may be updated in real-time. In one or more embodiments, the server computer system 120 may engage, for example, one or more application programming interfaces (APIs) to receive or obtain digital receipts from one or more third party payment cards.

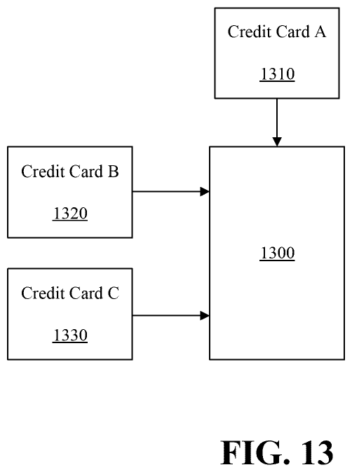

In embodiments where digital receipts from multiple payment cards are combined, consolidated or aggregated into the digital management application, the server computer system 120 may include a digital receipt aggregator. A flowchart representation of a digital receipt aggregator is shown in FIG. 13. As can be seen, a digital receipt aggregator 1300 receives digital receipts from a first digital receipt source 1310 associated with a Credit Card A, a second digital receipt source 1320 associated with a Credit Card B, and a third digital receipt source 1330 associated with a Credit Card C. In this example, the first digital receipt source 1310 may include the server computer system 120. The second digital receipt source 1320 may include a third party server computer system that may be associated with a provider of a third party payment card. The third digital receipt source 1330 may include a document uploaded by the user within the digital management application. The digital receipt aggregator 1300 may combine digital receipts received or obtained from the digital receipt sources and may store the digital receipts in the database 150 and/or may provide the digital receipts for display on a user interface within the digital receipt management application.

Although in embodiments described herein a single electronic address is used to receive the digital receipts, it will be appreciated that multiple electronic addresses may be used. For example, a user may wish to have digital receipts for personal purchases sent to a first email address and may wish to have digital receipts for business-related purchases sent to a second email address. In this example, the user may define merchants that are likely to be personal purchases and merchants that are likely to be business-related purchases. The user may additionally or alternatively define one or more locations that are likely to be personal purchases and one or more locations that are likely to be business-related purchases. For example, the user may live in a suburban area and may define purchases made within the suburban area as personal purchases. The user may work in a downtown area and may define purchases made within the downtown area as business-related purchases.

Although in embodiments described above, a token or payment card is described as being in the form of a credit card or a debit card, those skilled in the art will appreciate that in another embodiment the token may be associated with a mobile device of the user. For example, the token may be associated with a digital credit card stored within a mobile wallet on the mobile device of the user. Examples of such mobile wallets are Google Pay™, Apple Pay™, etc. In this example, the token may be read by the point-of-sale system 130 using, for example, near field communications (NFC).

The methods described above may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A server computer system comprising:
a communications module;
a processor coupled to the communications module; and
a memory coupled to the processor, the memory storing processor-executable instructions which, when executed, configure the processor to:
store, in a database, an indication that digital receipts are to be provided for all purchases made on a payment card;
receive, via the communications module and from a point-of-sale system, a signal requesting an indication that a digital receipt is to be provided for a purchase made on the payment card;
consult the database to determine that the digital receipt is to be provided for the purchase made on the payment card; and
send, via the communications module and to the point-of-sale system, a signal that includes the indication that the digital receipt is to be provided for the purchase made on the payment card.

2. The server computer system of claim 1, wherein the signal requesting the indication that the digital receipt is to be provided for the purchase made on the payment card is sent together with a transaction processing request.

3. The server computer system of claim 2, wherein the processor-executable instructions, when executed, further configure the processor to:
complete a transaction based on the transaction processing request; and
send, via the communications module and to the point-of-sale system, a signal that indicates completion of the transaction processing request.

4. The server computer system of claim 3, wherein the signal that indicates completion of the transaction processing request is sent together with the signal that includes the indication that the digital receipt is to be provided for the purchase made on the payment card.

5. The server computer system of claim 1, wherein the processor-executable instructions, when executed, further configure the processor to:
store, in the database, an electronic address for receiving the digital receipts, wherein the electronic address is sent together with the signal that includes the indication that the digital receipt is to be provided for the purchase made on the payment card.

6. The server computer system of claim 1, wherein the processor-executable instructions, when executed, further configure the processor to:
send, via the communications module and to a computing device, a signal that causes the computing device to display a user interface that includes a selectable option to receive the digital receipts; and
receive, via the communications module and from the computing device, a signal indicating selection of the selectable option to receive the digital receipts.

7. The server computer system of claim 6, wherein the user interface includes an input field for entering an electronic address for receiving the digital receipt and the processor-executable instructions, when executed, further configure the processor to:
receive, via the communications module and from the computing device, a signal that includes the electronic address for receiving the digital receipt; and
store, in the database, the electronic address for receiving the digital receipts.

8. The server computer system of claim 1, wherein the processor-executable instructions, when executed, further configure the processor to:
receive, via the communications module and from the point-of-sale system, a signal that includes the digital receipt for the purchase made on the payment card;
obtain an electronic address for receiving the digital receipt; and
send, via the communications module and to the electronic address, the digital receipt.

9. The server computer system of claim 8, wherein the processor-executable instructions, when executed, further configure the processor to:
prior to sending the digital receipt:
analyze the digital receipt to determine a transaction amount;
determine an amount of loyalty points earned based on the transaction amount; and
modify the digital receipt to include the amount of loyalty points earned based on the transaction amount.

10. The server computer system of claim 8, wherein the processor-executable instructions, when executed, further configure the processor to:
send, via the communications module and to a computing device, a signal that causes the computing device to display a user interface that includes the digital receipt.

11. The server computer system of claim 10, wherein the user interface displays a plurality of digital receipts and includes one or more interface elements for categorizing each digital receipt in one or more data buckets.

12. The server computer system of claim 1, wherein the indication indicating that digital receipts are to be provided for all purchases made on the payment card is stored in the database and sent to the point-of-sale system as a binary flag.

13. A computer-implemented method performed by a processor of a server computer system, the method comprising:
storing, in a database, an indication indicating that digital receipts are to be provided for all purchases made on a payment card;
receiving, via a communications module and from a point-of-sale system, a signal requesting an indication that a digital receipt is to be provided for a purchase made on the payment card;
consulting the database to determine that the digital receipt is to be provided for the purchase made on the payment card; and
sending, via the communications module and to the point-of-sale system, a signal that includes the indication that the digital receipt is to be provided for the purchase made on the payment card.

14. The computer-implemented method of claim 13, wherein the signal requesting the indication that the digital receipt is to be provided for the purchase made on the payment card is sent together with a transaction processing request.

15. The computer-implemented method of claim 14, further comprising:
completing a transaction based on the transaction processing request; and
sending, via the communications module and to the point-of-sale system, a signal that indicates completion of the transaction processing request.

16. The computer-implemented method of claim 15, wherein the signal that indicates completion of the transaction processing request is sent together with the signal that includes the indication that the digital receipt is to be provided for the purchase made on the payment card.

17. The computer-implemented method of claim 13, further comprising:
storing, in the database, an electronic address for receiving the digital receipts, wherein the electronic address is sent together with the signal that includes the indication that the digital receipt is to be provided for the purchase made on the payment card.

18. The computer-implemented method of claim 13, further comprising:
receiving, via the communications module and from the point-of-sale system, a signal that includes the digital receipt for the purchase made on the payment card;
obtaining an electronic address for receiving the digital receipt; and
sending, via the communications module and to the electronic address, the digital receipt.

19. The computer-implemented method of claim 18, further comprising:
prior to sending the digital receipt:
analyzing the digital receipt to determine a transaction amount;
determining an amount of loyalty points earned based on the transaction amount; and
modifying the digital receipt to include the amount of loyalty points earned based on the transaction amount.

20. A non-transitory computer-readable storage medium storing instructions that when executed by a processor of a computing system cause the computing system to:
store, in a database, an indication indicating that digital receipts are to be provided for all purchases made on a payment card;
receive, via a communications module and from a point-of-sale system, a signal requesting an indication that a digital receipt is to be provided for a purchase made on the payment card;
consult the database to determine that the digital receipt is to be provided for the purchase made on the payment card; and
send, via the communications module and to the point-of-sale system, a signal that includes the indication that the digital receipt is to be provided for the purchase made on the payment card.
